(19) United States
(12) Patent Application Publication
(10) Pub. No.: US 2002/0117391 A1
(43) Pub. Date: Aug. 29, 2002

(54) High purity CO2 and BTEX recovery

(76) Inventor: Craig A. Beam, Houston, TX (US)

Correspondence Address: Mark R. Wisner, c/o Wisner & Associates, Suite 930, 2925 Briarpark, Houston, TX, 77042, US

(21) Appl. No.: 10/058,559

(22) Filed: Jan. 28, 2002

Related U.S. Application Data
(60) Provisional application No. 60/265,540, filed on Jan. 31, 2001.

(51) Int. Cl. B01D 3/00; B01D 3/10; B01D 3/14

(52) U.S. Cl. 203/81; 203/87

(57) ABSTRACT

Method and apparatus for producing high purity, food grade CO₂ and recovering valuable BTEX fuel from hydrocarbon mixtures such as from a natural gas well. The method involves dehydrating the hydrocarbon mixture and separating the dehydrated mixture into gas and liquid phases, followed by further separation of the liquid phase to produce the BTEX fuel and condensation and distillation of the vapor phase to produce the high purity CO₂. The BTEX fuel is recovered at the temperature and pressure that meets specifications for transportation and storage of gasoline, facilitating its sale to market, and the high purity CO₂ is produced is produced as liquid CO₂ for storage and transportation.

### BACKGROUND OF THE INVENTION

The present invention relates generally to recovery of high purity carbon dioxide and so-called “BTEX” (benzene, toluene, E-benzene, and xylene) from hydrocarbon gas and, more particularly, to a method and apparatus for producing high purity CO₂ from hydrocarbon gas and for producing a marketable BTEX fuel from hydrocarbon gas.

Recent increases in the price of natural gas have had the effect of decreasing available supplies of carbon dioxide, particularly high purity, food grade CO₂. This problem was noted as long ago as 1983 when the application that issued as U.S. Pat. No. 4,460,395 was filed and has, if anything, become even more problematical in the last several months as the price of natural gas has increased more than twofold. CO₂ in varying quantities is a contaminant in many natural gas wells, and is found in substantial proportion of the wellhead product of some wells. However, it is expensive to remove contaminants from natural gas CO₂ sources to an extent that food grade specifications can be met.

Processes for purifying CO₂ are known in the art; several are described in the aforementioned U.S. Pat. No. 4,460,395 and that patent, and its discussion of several prior art patents, is hereby incorporated herein in its entirety by this specific reference thereto. Briefly, known methods for recovering CO₂ from natural gas or other hydrocarbon sources take the form of high speed, rotating cryogenics equipment that is relatively expensive to acquire and to maintain, membrane technology that is relatively complicated, expensive, and slow, and oxidation methods with distillation that result in the loss of appreciable quantities of valuable product. So far as is known, in spite of the need for high purity, food grade CO₂, none of the available methods, or the methods described in the prior art patents listed in U.S. Pat. No. 4,460,395, is in widespread use at this time. It is therefore apparent that there is a need for an improved method for purifying CO₂ from natural gas sources, and it is one of the objects of the present invention to provide such an improved method.

Of course the aromatic BTEX hydrocarbons that are found in natural gas are a hazard in the environment such that it is important to remove them from natural gas as well. It is, therefore, another object of the present invention is to provide a method for removing BTEX from natural gas sources.

Not only is it an object of the present invention to provide a method for removing BTEX from natural gas, but it is also an object of the present invention to remove these aromatic hydrocarbons from the natural gas in such purity as to enable their use as a fuel stock. So-called BTEX fuel is too valuable a source of energy to waste, and it is therefore an object of the present invention to recover this valuable energy from the natural gas produced from the well.

Another object of the present invention is to provide methods for recovering high purity CO₂ and BTEX fuel that do not emit harmful substances to the air or water and therefore eliminate and/or reduce the need for new (and expensive) permits.

Another object of the present invention is to provide a method, and an apparatus for implementing that method, of recovering CO₂ and BTEX fuel from natural gas sources that avoid reclassifying the process plant to explosion proof by making it possible to keep the richer vent gases away from the compressors and motors.

Yet another object of the present invention is to provide a method of recovering BTEX fuel from a natural gas source that is implemented in such a way that the concentration of benzene in any pipe in the process does not exceed 10% of the total flow, thereby avoiding the need for even more expensive, more stringent permits.

Other objects, and the many advantages, of the present invention will be made apparent by the following description of the presently preferred embodiments thereof

### SUMMARY OF THE INVENTION

These objects are met in a first aspect of the present invention by providing a method for purifying carbon dioxide from a hydrocarbon gas mixture comprising the steps of removing water from the hydrocarbon gas mixture, separating the hydrocarbon gas mixture into vapor, light liquid, and heavy liquid phases to remove the light liquid, and distilling the separated vapor phase to remove light hydrocarbons therefrom and produce liquid carbon dioxide. The liquid carbon dioxide is then polished by passing the CO₂ through activated carbon beds to give high purity, food grade CO₂.

In a second aspect, the present invention provides a method of producing BTEX fuel from a hydrocarbon gas mixture. This second method comprises the steps of removing water from the hydrocarbon gas mixture, separating the hydrocarbon gas mixture into vapor and liquid phases, and heating the liquid phase to approximately 80° F. The liquid phase is then separated in a three-phase high pressure tank into vapor, water, and liquid hydrocarbon phases, the liquid hydrocarbon phase including the BTEX hydrocarbons. The liquid hydrocarbon phase, including the BTEX hydrocarbons, is then drawn off of the water phase in the high pressure tank and the liquid hydrocarbon phase from the high pressure tank is then stabilized in a two phase tank at a pressure lower than the pressure in the high pressure tank, thereby further separating vapor from the liquid hydrocarbon phase to produce BTEX fuel.

### BRIEF DESCRIPTION OF THE DRAWINGS

FIG. 1 is a schematic diagram of a preferred embodiment of a method of purifying CO₂ from a hydrocarbon mixture in accordance with the teachings of the present invention.

FIG. 2 is a schematic diagram of a preferred embodiment of an apparatus for purifying CO₂ from a hydrocarbon mixture in accordance with the teachings of the present invention.

FIG. 3 is a schematic diagram of the three phase, high pressure separation tank that comprises a portion of the apparatus of FIG. 2.

FIG. 4 is schematic diagram of the distillation columns comprising a portion of the apparatus of FIG. 2.

### DESCRIPTION OF THE PREFERRED EMBODIMENT

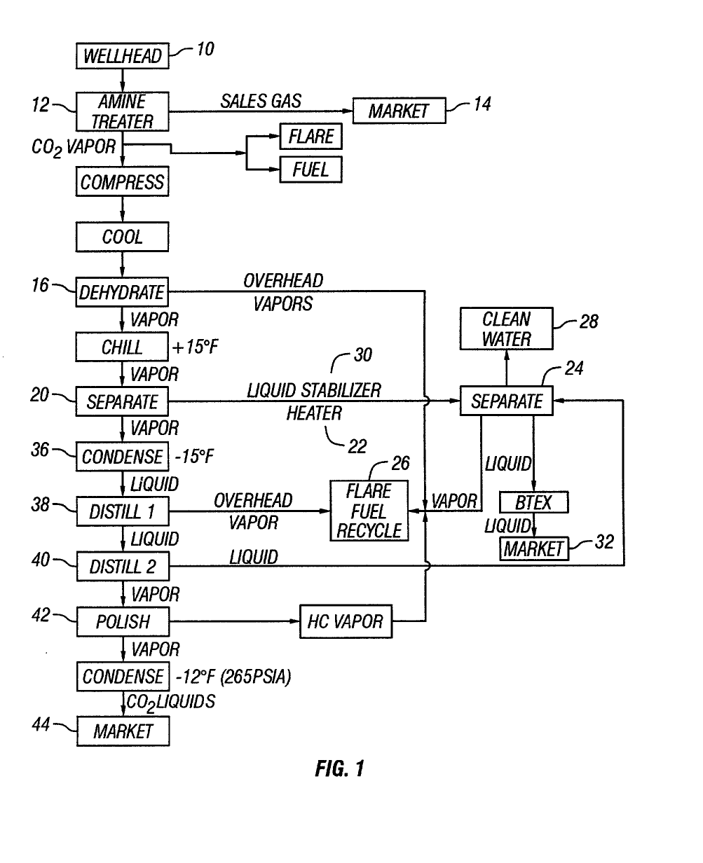

Both the method and apparatus described herein are optimized for a typical CO₂ process plant that might produce approximately 250 tons of CO₂ per day. Those skilled in the art will recognize, however, that it may be necessary to make certain changes in the preferred embodiments described herein in accordance with the production specifications for a particular CO₂ process plant. Referring to FIG. 1, there is shown a schematic diagram of a preferred method of purifying CO₂ from a hydrocarbon mixture in accordance with the teachings of the present invention. At the wellhead 10, the natural gas includes water and a number of other impurities such that the natural gas undergoes inlet separation and filtration to remove entrained solids, followed by stripping. Amine stripping is generally the method of choice such that this process is summarized by the reference to amine treatment at reference numeral 12 in FIG. 1. The resulting natural gas is sent to market as at reference numeral 14 and the remaining hydrocarbon mixture is the inlet stream for the method of the present invention.

In the first step of the method of the present invention, the hydrocarbon mixture resulting from the stripping of natural gas is dehydrated as at step 16. Dehydration can be accomplished in several ways as known in the art such as by injecting methanol to eliminate hydration formation and freezing of the water to allow separation of water from the hydrocarbon mixture, by ethylene glycol dehydration tower, or by equivalent methods. Methanol injection is preferred for dehydration in the method of the present invention, and the methanol is preferably injected upstream of a heat exchanger (not shown in FIG. 1) to give better mixing with the hydrocarbon mixture and subsequent separation of liquid and vapor at approximately 15° F. as at step 20. Separation step 20 is preferably accomplished at relatively high pressures of about 300-320 psia.

Liquid from separator 20, which includes water, heavier (long chain) hydrocarbons, and heavier (BTEX) hydrocarbons, is heated as at 22 to about 80° F. and, while still at about 290 psia, undergoes a second separation step as at 24. In the preferred embodiment, this second separation step is accomplished by quiet separation in a three phase, high pressure tank separator, described in more detail below. Vapor from this second separation step 24 is flared as at step 26 or optionally recycled (for instance, to the inlet stream) and clean water is dumped as at 28. The remaining liquid, comprising mainly heavier chain and aromatic hydrocarbons, is then stabilized at step 30 by heating to a slightly higher temperature (about 90° F.) and storing in a two-phase separation tank at a much lower pressure of approximately 20 psia. The vapors from this stabilization step 30 are once again flared as at 26 or optionally recycled and the resulting stabilized liquid, in the form of valuable BTEX fuel, is marketed as at step 32.

Returning to separator 20, the vapor is cooled at step 36 from about +15° F. to about −15° F. while pressure is maintained at about 290 psia. The vapor is then distilled at step 38. Overhead vapors from distillation column 38 are flared at step 26. The liquid bottoms from distillation column 38 are distilled at step 40, but in this second distillation step 40, the liquid bottoms are routed to the high pressure separation tank 24 and it is the vapor that includes the high purity CO₂. The vapor from second distillation step 40 is then polished by absorption at step 42 through activated carbon and then condensed to give high purity, food grade liquid CO₂ to market 44.

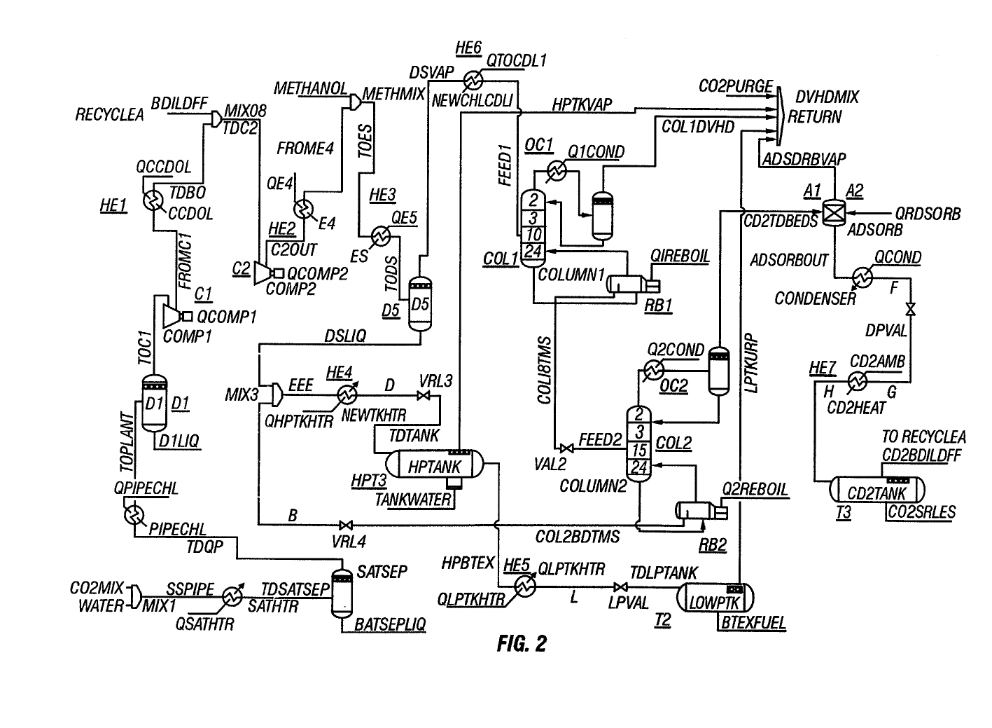

Referring now to FIG. 2, there is shown a schematic diagram of a preferred embodiment of an apparatus for. recovering high purity CO₂ and the valuable BTEX fuel from a hydrocarbon mixture such as from a natural gas well that is constructed in accordance with the present invention. Those skilled in the art will recognize that, although reference is made herein to recovering CO₂ and BTEX fuel from a natural gas well, the method and apparatus of the present invention are also adaptable for recovering one or the other, or both, of these valuable products from almost any hydrocarbon source with modification of specific operating parameters in a manner that will be known to those skilled in the art who have the benefit of this disclosure as may be needed depending upon the content and components of the inlet gas. For this reason, the inlet gas to the method and apparatus of the present invention is referred to herein as a “hydrocarbon mixture.”

In the preferred embodiment shown in FIG. 2, a hydrocarbon mixture such as results from amine stripping of natural gas is routed first through a free water, knock-out, two-stage carbon steel separator D1 and then to a rotary screw, oil flooded compressor C1. Those skilled in the art will recognize that compressor C1 could also be a reciprocating compressor. The output stream from compressor C1 is cooled in an ammonia, water, or air cooled carbon steel tube heat exchanger. HE1 and then compressed in a second rotary screw compressor C2 to approximately 300 psig and further cooled in a second heat exchanger HE2. Compressor C2 can also be a reciprocating compressor, but may handle more vapor than compressor C1 due to recycling. Heat exchanger HE2 is also an ammonia, water, or air-cooled carbon steel tube heat exchanger.

For dehydration, methanol is injected into the output stream of heat exchanger HE2 upstream of a third heat exchanger HE3 (to give better mixing) that prevents hydrate formation and freezing of the water vapor for subsequent separation of the water vapor in three phase separator D5 at about +15° F. Heat exchanger HE3 is also a carbon steel tube beat exchanger, but because of the temperature, must be cooled with ammonia or chilled glycol. Separator D5 is of a type known in the art with internal baffles and coalescing mesh pad for removing liquids from a vapor stream. The cold liquid from separator D5 includes heavier hydrocarbons, water, and the heavier, aromatic BTEX hydrocarbons and the cold vapor output from separator D5 includes light hydrocarbons and CO₂.

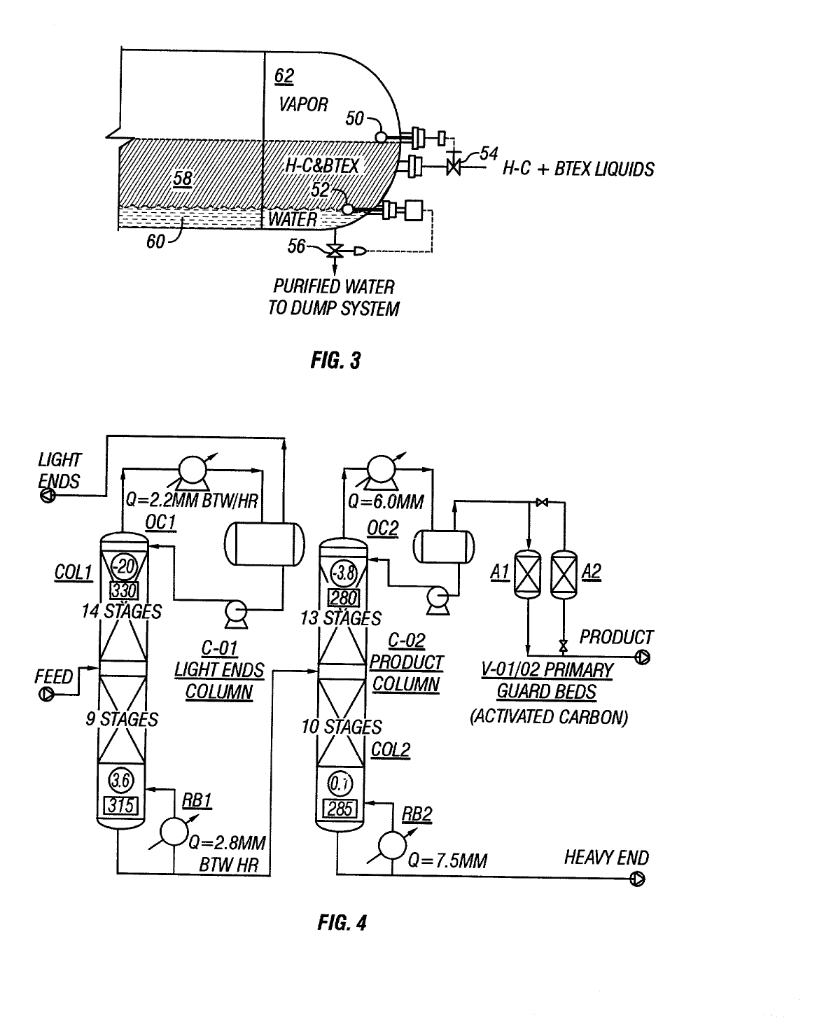

The cold liquid output from separator D5 is heated in heat exchanger HE4 with either hot CO₂ vapor or hot ammonia to about +80° F. and, still at about 250 psia, is routed to a large tank for high pressure, “quiet” separation in high pressure tank HPT3, shown in FIG. 3. High pressure tank HPT3 is a large, horizontal propane, or so-called “bullet-type” tank with a three stage “tail end” outlet and a design working pressure of about 250 psig, operating at about 220-230 psig and an 80-90° F. stabilization temperature. Referring to FIG. 3, it can be seen that tank HPT3 includes liquid floats 50, 52 and valves 54, 56 for two layers of liquid. High pressure tank HPT3 is preferably at least a 30,000 gallon tank so that the liquid that accumulates therein resides in the tank long enough for the liquid to de-gas and to separate into hydrocarbon/BTEX and water layers 58, 60. The float 50 rides on the hydrocarbon/BTEX layer 58 and that layer 58 is drawn off through valve 54 when that layer 58 accumulates to a specified level. Similarly, the float 52 rides at the interface between the hydrocarbon/BTEX layer 58 and the water layer 60 and water is dumped through valve 56. Vapors in the ullage 62 of high pressure tank HPT3 are periodically drawn off and routed to a waste flare or optionally recycled to separator D1.

The hydrocarbon/BTEX liquid drawn from high pressure tank HPT3 is heated in heat exchanger HE5 to about 85-90° F. and pressure is dropped to about 20 psia to match gasoline storage and transportation specifications for highway hauling of the BTEX fuel. However, before the BTEX fuel is ready to market, it is preferably separated in a two-phase (liquid and vapor) separator tank T2. Tank T2 is also preferably a bullet-type horizontal tank that is provided with a liquid level indicator of the type described above. Vapors from the ullage of tank T2 are periodically drawn off and routed to a waste flare or optionally recycled to separator D1 and, when the liquid level indicator reaches a high enough level, the valuable BTEX fuel is drained from the tank for transport to market.

Returning now to separator D5 on FIG. 2, the vapors are routed to another heat exchanger HE6 to further decrease to the condensation temperature of about −15° F. Again because of the temperatures, heat exchanger HE6 is ammonia or glycol chilled. The cold liquids are then introduced into approximately the middle of distillation column COL1 for rejection of hydrocarbon ethanes (and lighter). As shown in FIG. 4, the light end vapors are stripped off with an overhead condenser OC1 that may be internal or external to column COL1 (reflux rate of about 1.5 to 4.0 cycles depending on refrigeration economics), and are routed to a waste flare or optionally recycled to separator D1. The heavy ends are concentrated as liquid with a reboiler RB1 and, as can be seen by reference to FIG. 4, introduced into the midpoint of a second distillation column COL2. Second column COL2 rejects the liquids and the vapors are refluxed several times (reflux rates of about 1 to 3 cycles), condensing each time at overhead condenser OC2 and removing about 6 million BTU/hour each time (depending again upon economics), to stabilize the effluent. Heavy ends are concentrated by reboiler RB2 and recycled back to high pressure separation tank HPT3. As can be seen by reference to the operating parameters of distillation columns COL1 and COL2 in FIG. 4, the reboilers RB1 and RB2 add a relatively large amount of heat relative to the cold temperatures in the columns COL1 and COL2 to provide good flow in both directions. The reboiler RB2 for column COL2 needs even more energy to operate than RB1, so heat is about 4-8 million BTU/hour.

The cold (approximately −4° F.) vapor stream from the product distillation column COL2 is routed to an absorption bed of activated carbon for final polishing. In the preferred embodiment shown in FIG. 4, two absorption beds A1 and A2 are provided and, because of the relatively high ethane and propane levels compared to food grade in the input vapor, the input stream is switched from bed A1 to bed A2 approximately every four hours (or such other interval as required by the hydrocarbon content of the particular vapor) with purging of the other bed with high purity CO₂. Of course bed diameter and height is optimized in the manner known in the art for a particular flow rate through the bed. The vapor output from absorption beds A1 and A2 (at about 0 to −1° F.) is routed through another heat exchanger HE7 to liquefy the high purity CO₂ at about −12° F. and the high purity CO₂ is then stored in a conventional horizontal bullet-type storage tank T3 that may be high pressure with an internal liquid level indicator. Boil-off from tank T3 that is not used for purging is recycled to the input stream to compressor C2 (see FIG. 2) at about 70-80 psia and, as needed, to purge and cool the absorption beds A1 and A2 during regeneration.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiments described are selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

What is claimed is:

1. A method for purifying carbon dioxide from a hydrocarbon gas mixture comprising the steps of:
removing water from the hydrocarbon gas mixture;
separating the hydrocarbon gas mixture into vapor, light liquid, and heavy liquid phases to remove the light liquid;
distilling the separated vapor phase to remove light hydrocarbons therefrom and produce liquid carbon dioxide; and
polishing the liquid carbon dioxide.

2. A method of producing BTEX fuel from a hydrocarbon gas mixture comprising the steps of:
removing water from the hydrocarbon gas mixture
separating the hydrocarbon gas mixture into vapor and liquid phases;
heating the liquid phase to approximately 80° F. and separating the heated liquid phase in a three-phase high pressure tank into vapor, water, and liquid hydrocarbon phases, the liquid hydrocarbon phase including the BTEX hydrocarbons; and
drawing the liquid hydrocarbon phase including the BTEX hydrocarbons off of the water phase in the high pressure tank; and
stabilizing the liquid hydrocarbon phase from the high pressure tank in a two phase tank at a pressure lower than the pressure in the high pressure tank, thereby further separating vapor from the liquid hydrocarbon phase to produce BTEX fuel therefrom.
